(19) United States
(12) Patent Application Publication
(10) Pub. No.: US 2010/0020971 A1
(43) Pub. Date: Jan. 28, 2010

(54) Device and Method for a Secure Transaction

(76) Inventors: Richard HANKS, Seattle, WA (US); Russell Calvarese, Stony Brook, NY (US); Shane MaCgregor, Forest Hills, NY (US); Jeffrey Weissman, South Setauket, NY (US)

Correspondence Address: MOTOROLA, INC., 1303 EAST ALGONQUIN ROAD, IL01/3RD, SCHAUMBURG, IL, 60196, US

(21) Appl. No.: 12/179,075

(22) Filed: Jul. 24, 2008

(51) Int. Cl. H04L 9/00

(52) U.S. Cl. 380/255

(57) ABSTRACT

A device comprises a first processor and a second processor. The first processor is connected to a display, a data input arrangement, and a data acquisition device in a first mode of operation. The first mode of operation relates to performing non-secure operations. The second processor is connected to the display, the data input arrangement, and the data acquisition device in a second mode of operation. The second mode of operation relates to performing a secure operation. The secure operation relates to a sales transaction. When the device is in the second mode of operation, the data acquisition device receives secure data from a remote source. The secure data is forwarded to the second processor to determine a success of the sales transaction.

### FIELD OF THE INVENTION

The present invention relates generally to a device and method for a secure transaction. Specifically, the device utilizes a common data input arrangement and display for secure operations and non-secure operations.

### BACKGROUND

In a retail environment, a computing device such as a cash register may be part of an arrangement for a transaction. The arrangement may enable an owner of a purchasing means to provide secure data, thereby charging the owner for a purchase of an item. In the case of a credit card, the secure data may be a credit card number and/or a card verification number (CVN). In the case of a debit card, the secure data may be a debit card number and/or a personal identification number (PIN). The secure data may only be known by the owner of the purchasing means and also may be used as a means to indicate that it is owner who is providing the information.

The arrangement for the transaction may also require a module to receive the secure data. The module may ensure that the secure data is not accessible by an interceptor such as a rogue program. The module may encode the secure data prior to transmission to the computing device. The module may include its own display and data input arrangement that is separate from the computing device to guarantee that the secure data is not accessible. That is, the secure data is entered through the module that is designed specifically to receive the secure data. Transaction arrangements that do not include the module may not be properly configured to provide such security. However, the transaction arrangement that includes the module further includes at least an additional display and an additional data input arrangement. These additional components that are already available in the computing device add costs to the manufacturer.

### SUMMARY OF THE INVENTION

The present invention relates to a device that comprises a first processor and a second processor. The first processor is connected to a display, a data input arrangement, and a data acquisition device in a first mode of operation. The first mode of operation relates to performing non-secure operations. The second processor is connected to the display, the data input arrangement, and the data acquisition device in a second mode of operation. The second mode of operation relates to performing a secure operation. The secure operation relates to a sales transaction. When the device is in the second mode of operation, the data acquisition device receives secure data from a remote source. The secure data is forwarded to the second processor to determine a success of the sales transaction.

### DESCRIPTION OF THE DRAWINGS

FIG. 1 shows a mobile unit according to an exemplary embodiment of the present invention.

FIG. 2 shows a first set of components for the mobile unit of FIG. 1 according to an exemplary embodiment of the present invention.

FIG. 3 shows a second set of components for the mobile unit of FIG. 1 according to an exemplary embodiment of the present invention.

FIG. 4 shows a third set of components for the mobile unit of FIG. 1 according to an exemplary embodiment of the present invention.

FIG. 5 shows a method for performing a secure transaction according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a device and method for a secure transaction. According to the exemplary embodiments of the present invention, the device provides the secure transaction to be performed using a common display and a common data input arrangement. The device may eliminate a need for a module that is specifically designed to provide secure data to be used for the secure transaction. The device, the components of the device, the secure transaction, and an associate method will be discussed in further detail below.

The following description illustrates that the device may be a mobile unit (MU). For example, in a retail environment, the MU may be provided to a customer. The MU may provide the customer with various information relating to the retail environment and contents within the retail environment. The MU may also enable a “check-out” feature that enables the customer to scan objects that are to be purchased. Accordingly, the MU may receive secure data from the customer to complete the purchasing transaction.

It should be noted that the following description in which the device is a mobile unit (MU) is only exemplary. The exemplary embodiments of the present invention may generally apply to any computing device that is capable of performing the secure transaction. For example, the device may be a stationary computing device such as a cash register. Furthermore, it should be noted that the following description relates to a sales transaction. However, the exemplary embodiments of the present invention may generally apply to any device performing a secure operation and a non-secure operation.

The following description differentiates between non-secure operations and secure operations being executed on the MU. Those skilled in the art will understand that a non-secure operation may be any operation that does not include entering or exchanging sensitive or confidential data. A secure operation may be any operation that includes entering or exchanging sensitive or confidential data. It should be noted that entering or exchanging encoded data may be categorized as part of a non-secure operation. That is, it may be assumed that the encoded data may only be decrypted by predetermined parties and, thus, the encoded data may encrypt sensitive or confidential data but the encoding generates data that is not sensitive or confidential.

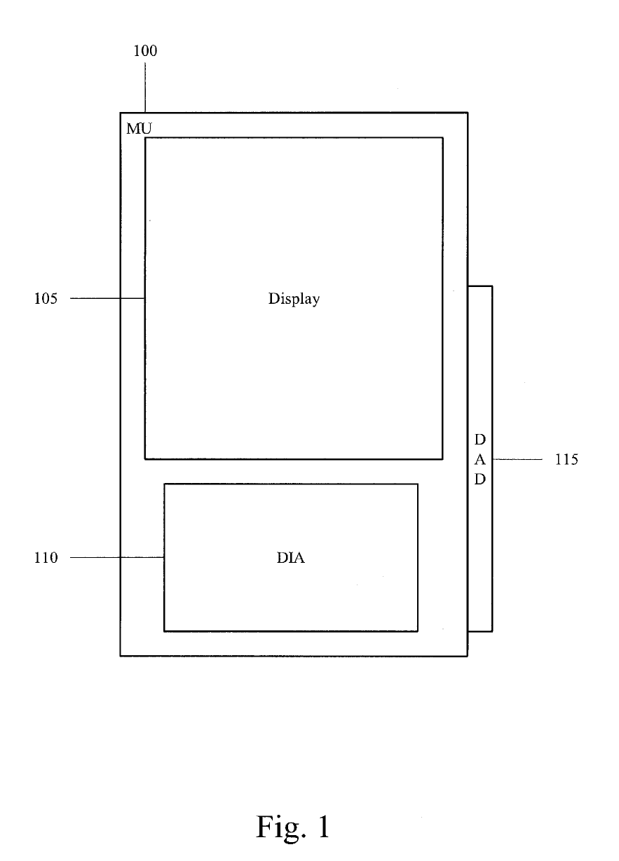

FIG. 1 shows a MU 100 according to an exemplary embodiment of the present invention. The MU 100 may be any electronic portable device such as a mobile computer, a personal digital assistant (PDA), a laptop, a scanner, an RFID reader, an image capturing device, a pager, a cellular phone, etc. The MU 100 may include a display 105, a data input arrangement (DIA) 110, and a data acquisition device (DAD) 115.

The display 105 may be a component of the MU 100 configured to show data to a user. The data may be, for example, related to a functionality or a program being executed on the MU 100. The display 105 may be a cathode ray tube (CRT) display or a liquid crystal display (LCD). The display 105 may also be a touch screen display that is configured to receive tactile inputs from the user on an external surface of the display 105. The tactile inputs may be, for example, from a stylus or a finger of the user. According to the exemplary embodiments of the present invention, the display 105 may be used for non-secure operations and secure operations of the MU 100. For example, the display 105 may show scanned items to be purchased or an entering of digits for a PIN.

The DIA 110 may be configured to receive inputs from the user. The DIA 110 may be, for example, a keypad (e.g., numeric, alphanumeric, QWERTY, etc.). As discussed above, the display 105 may be a LCD with a touch screen. In this exemplary embodiment, the DIA 110 may be incorporated with the display 105. Thus, it should be noted that the DIA 110 being disposed as a separate unit from the display 105 is only exemplary. According to the exemplary embodiments of the present invention, the DIA 110 may be used for non-secure operations and secure operations. For example, the DIA 110 may receive a set of digits relating to a universal product code (UPC) of a product to be purchased or receive a set of digits relating to a PIN.

The DAD 115 may be any component that is configured to receive data from a remote source. For example, the DAD 115 may be a magnetic strip reader. A user may swipe, for example, a credit/debit card that includes a magnetic strip that is encoded with data relating to the card. The DAD 115 may receive the data. In another example, the DAD 115 may be a radio frequency identification (RFID) reader. The RFID reader may receive radio frequency (RF) data from, for example, a “smart” card that includes a passive RFID tag. In a further example, the DAD 115 may be a scanner (e.g., laser based scanner, imager based scanner, etc.). The scanner may scan an object (e.g., one-dimensional barcode, two-dimensional barcode, color barcode, image, optical character recognition (OCR) string, etc.) to receive the data encoded in the object. According to the exemplary embodiments of the present invention, the DAD 115 may be used for non-secure operations and secure operations. For example, the DAD 115 may be a barcode scanner that scans a UPC barcode for an item to be purchased. The DAD 115 may also be a magnetic strip reader that receives raw data of a credit card. The raw data may be in a form that may only be decrypted by a predetermined application.

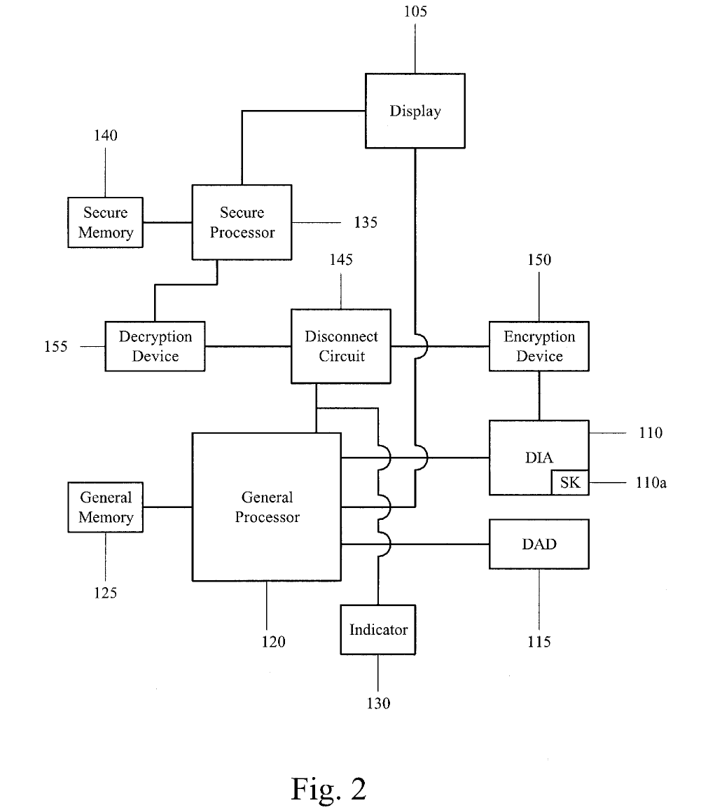

FIG. 2 shows a first set of components for the MU 100 of FIG. 1 according to an exemplary embodiment of the present invention. FIG. 2 illustrates a circuit diagram of the first set of components. The first set of components may include the display 105, the DIA 110, a secure key 110a, the DAD 115, a general processor 120, a general memory 125, an indicator 130, a secure processor 135, a secure memory 140, a disconnect circuit 145, an encryption device 150, and a decryption device 155. It should be noted that the display 105, the DIA 110, and the DAD 115 correspond to the respective components described above with reference to FIG. 1. Thus, like reference numerals are used. However, the following description of FIG. 2 relates to the circuitry for these components.

The general processor 120 may be responsible for executing functionalities of the MU 100. Specifically, according to the exemplary embodiments of the present invention, the general processor 120 may execute non-secure operations of the MU 100. For example, the general processor 120 may execute a customer shopping program that scans items to be purchased using the DAD 115. As discussed above, the display 105, the DIA 110, and the DAD 115 may be used with non-secure operations of the MU 100. Thus, when the general processor 120 is connected to the display 105, the DIA 110, and the DAD 115, the general processor 120 may hold a primary control to the these components.

The general processor 120 may also be configured to be disconnected from the display 105, the DIA 110, and/or the DAD 115 upon a predetermined action being performed. For example, according to the exemplary embodiment of FIG. 2, the secure key 110a may be an input of the DIA 110. In another example, the secure key 110a may be a separate input not associated with the DIA 110. As a separate input, the secure key 110a may include a dedicated connection to the general processor 120.

The user may activate the secure key 110a to indicate to the general processor 120 that secure data is to be entered and/or exchanged. The secure key 110a may also indicate to the general processor 120 to initiate the indicator 130. The indicator 130 may provide the user with a signal that secure data may be entered. The signal may be, for example, an activating of a light emitting diode (LED), an alteration of a background color on the display 105, etc. The general memory 125 may be any storage component that stores data relating to the non-secure operations performed by the general processor 120.

When the general processor 120 becomes disconnected, the secure processor 135 may be connected to the display 105 and the DIA 110. Once connected, the secure processor 135 may receive inputs entered from the DIA 110. The inputs may be, for example, secure data such as a CVN or a PIN. The disconnect circuit 145 may provide a secure pathway for the secure data to be forwarded from the DIA 110 to the secure processor 135 when the secure key 110a has been activated. The secure processor 135 may also be connected to the general processor 120 that receives secure data in a form of raw data from the DAD 115. The DAD 115 may forward the raw data received from the remote source to the general processor 120. The general processor 120 may be incapable of interpreting or decrypting the raw data and may only be capable of forwarding the raw data to the secure processor 135.

The secure memory 140 may be a storage device dedicated to the secure processor 135. The secure memory 140 may store the secure data (e.g., raw data of the remote source entered via the DAD 115, CVN/PIN entered via the DIA 110, etc.). The secure processor 135 may process the raw data to determine data relating to the remote source. For example, if the DAD 115 is a magnetic strip reader and the remote source is a credit/debit card, the DAD 115 may forward the raw data to the general processor 120 which forwards the data to the secure processor 135. The secure processor 135 may decrypt the raw data to determine account information relating to the card. The secure processor 135 may determine a validity of the raw data from the remote source. Thus, a verification may be determined. When secure data such as the CVN or PIN is entered, the secure processor 135 may also determine whether the secure data that is entered corresponds to the account information. It should be noted that the MU 100 may include a transceiver to connect to a network component. The network component may include a database that includes the correspondence between the decrypted raw data and the secure data.

The display 105 may show data relating to the secure operation being performed by the secure processor 135 when the secure key 110a has been activated. For example, when the CVN or the PIN is entered, the display 105 may show the entry of each digit. The digit may be encoded so that the display 105 merely shows that a digit has been entered.

Once the secure data has been verified by the secure processor 135, the secure processor 135 may send encrypted data to the general processor 120 that indicates to the general processor 120 that the verification has been performed and was successful. Once the verification is complete and secure data is no longer required to be exchanged between the components, the secure processor 135 may disconnect from the components while the general processor 120 again connects to the components. The general processor 120 may subsequently complete any non-secure operation that utilizes the encrypted data received from the secure processor 135 (e.g., sales transaction).

To further ensure that the secure data is properly transmitted, the encryption device 150 may be disposed between the DIA 110 and the general processor 135. As discussed above, the secure data is entered via the DIA 110 and received by the secure processor 135. However, if the connector between the DIA 110 and the secure processor 135 is compromised (e.g., tapped, sniffed, etc.), the secure data may also be compromised. The encryption device 150 may ensure that the secure data such as a PIN is encrypted while being transmitted through the connector. The decryption device 155 may decrypt the encrypted secure data prior to the secure processor 135 receiving the secure data. The encryption device 150 and the decryption device 155 may be, for example, a Triple Data Encryption Standard (TDES) device.

It should be noted that the encryption device 150 may be incorporated with the DIA 110. Thus, prior to any secure data being transmitted through the connector, the secure data is initially encrypted. Accordingly, the decryption device 155 may be incorporated with the secure processor 135. Thus, through the secure data being transmitted through the connector, the secure data is encrypted. It should also be noted that when the display 105 is a touch screen that receives data, the encryption device 150 or a further encryption device may be disposed at substantially similar locations to encrypt the secure data to prevent the secure data from being intercepted.

According to the exemplary embodiment of the configuration of the first set of components, the secure processor 135 may forward the encrypted data at different predetermined times. In a first example, after entering the raw data via the DAD 115 or the secure data via the DIA 110, the user may deactivate the secure key 110a. This may indicate to the secure processor 135 that the secure data has been entered and the verification is to be performed. Once complete, the secure processor 135 may forward the encrypted data and disconnect from the components. In a second example, the forwarding of the encrypted data and the disconnect from the components may be automatic. That is, once the secure processor 135 performs the verification, the encrypted data may be forwarded and the disconnect from the components may occur. The indicator 130 may be deactivated and/or a further indication may be provided to the user to denote that the secure operation has terminated and the non-secure operation has resumed.

It should be noted that the term “disconnected” may relate to a physical connection, an electrical connection, or a virtual connection in which data exchange is enabled between the components (e.g., display 105, DIA 110, DAD 115) and the general processor 120. The term “disconnected” as used in the above description relates to the general processor 120 no longer having access to the components (e.g., electrical connection). For example, the general processor 120 may not show data on the display 105, receive inputs from the DIA 110, etc. According to the exemplary embodiments of the present invention, the term “disconnected” may also relate to the general processor 120 no longer having a primary control over the components. That is, the general processor 120 may still be activated and operational to, for example, receive raw data from the DAD 115.

[is the disconnect circuit 145 used as part of the disconnect of the general processor 120 from the display/keypad and connect of the secure processor 135 to the display/keypad? Or is the disconnect circuit used to prevent overloads to the processors? Does the disconnect circuit have another purpose? Other purposes?]

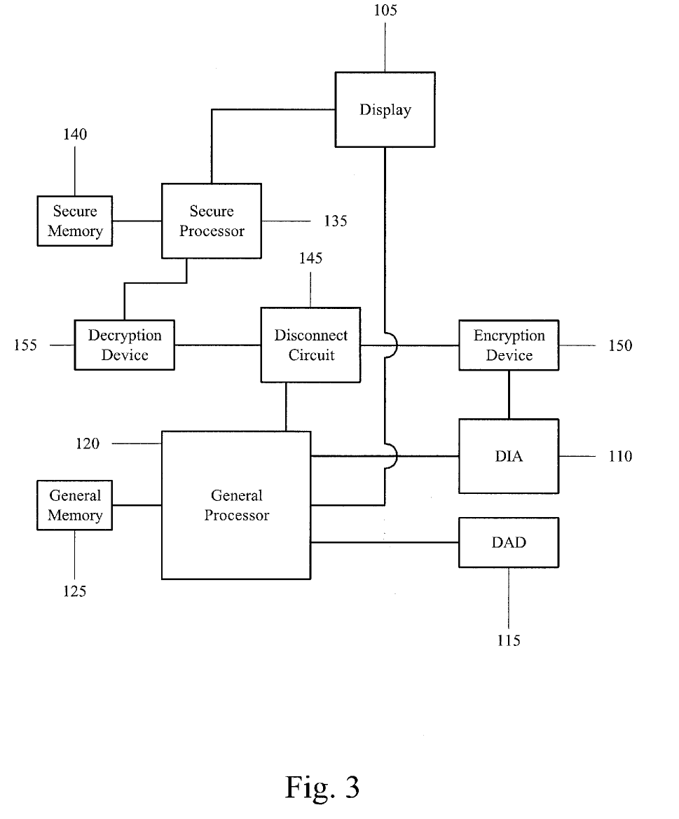

FIG. 3 shows a second set of components for the MU 100 of FIG. 1 according to an exemplary embodiment of the present invention. FIG. 3 illustrates a circuit diagram of the second set of components. The second set of components may include the display 105, the DIA 110, the DAD 115, the general processor 120, the general memory 125, the secure processor 135, the secure memory 140, the disconnect circuit 145, the encryption device 150, and the decryption device 155. It should again be noted that the display 105, the DIA 110, and the DAD 115 correspond to the respective components described above with reference to FIG. 1. Thus, like reference numerals are used. However, the following description of FIG. 3 relates to the circuitry for these components. It should also be noted that each of the second set of components may be substantially similar to the corresponding component of the first set of components. For example, the general memory 125 may perform a substantially similar function in the configuration of the first set of components of FIG. 2 and the configuration of the second set of components of FIG. 3.

In contrast to the configuration of the first set of components of FIG. 2, the configuration of the second set of components may not include the secure key 110a on the DIA 110 and the indicator 130. In this exemplary embodiment of the present invention, the disconnect from the general processor 120 and the connect to the secure processor 135 of the components may be automatic. Specifically, when the DAD 115 receives the data from the remote source, raw data received by the general processor 120 may indicate that secure data is entered. For example, the DAD 115 may be connected to predetermined pins on a circuit board in which the general processor 120 is disposed. When activity is detected on the predetermined pins, the general processor 120 may be aware that the raw data is received and the disconnect from the components is to occur.

Once the indication of the secure data to be entered has been determined, the general processor 120 may disconnect from the components while the secure processor 135 connects to the components. The secure processor 135 and the general processor 120 may perform the verification in a substantially similar manner as discussed above with reference to the first set of components of FIG. 2. Furthermore, upon completion of the verification, the disconnect from the secure processor 135 and the connect to the general processor 120 of the components may be automatic. The automatic connect/disconnect may also be substantially similar to the process discussed above with reference to the first set of components of FIG. 2.

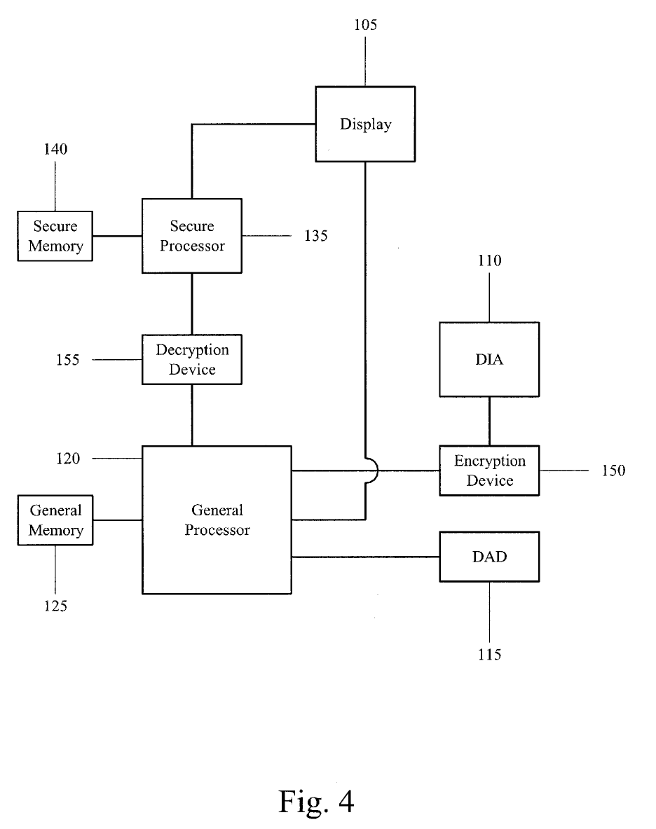

FIG. 4 shows a third set of components for the MU 100 of FIG. 1 according to an exemplary embodiment of the present invention. FIG. 4 illustrates a circuit diagram of the third set of components. The third set of components may include the display 105, the DIA 110, the DAD 115, the general processor 120, the general memory 125, the secure processor 135, the secure memory 140, the encryption device 150, and the decryption device 155. It should again be noted that the display 105, the DIA 110, and the DAD 115 correspond to the respective components described above with reference to FIG. 1. Thus, like reference numerals are used. However, the following description of FIG. 4 relates to the circuitry for these components. It should also be noted that each of the third set of components may be substantially similar to the corresponding component of the first set of components. For example, the general memory 125 may perform a substantially similar function in the configuration of the first set of components of FIG. 2 and the configuration of the third set of components of FIG. 4.

In contrast to the configuration of the second set of components of FIG. 3, the configuration of the third set of components may not include the disconnect circuit 145. In this exemplary embodiment of the present invention, the disconnect from the general processor 120 and the connect to the secure processor 135 of the components may also be automatic. The indication that secure data is to be entered may be substantially similar to the indication described above with reference to the second set of components of FIG. 3.

Because the configuration of the third set of components may not include the disconnect circuit 145 (as described above with reference to the first set of components of FIG. 1 and the second set of components of FIG. 2), the DIA 110 may be connected to only the general processor 120. Because the DIA 110 does not include a connection to the secure processor 135, when secure data is entered via the DIA 110, the general processor 120 may initially receive the secure data. Furthermore, secure (encrypted) and non-secure (unencrypted) data may be exchanged between the general processor 120 and the secure processor 135. According to the exemplary embodiment of the present invention, the secure processor 135 may include a modified driver for the DIA 110. The modified driver may enable the secure processor 135 to receive the non-secure data from the general processor 120. The general processor 120 may also be designed to be incapable of decrypting and/or performing a process relating to secure data received via the DIA 110. The general processor 120 may, however, be designed to forward the secure data to the secure processor 135.

Once the indication of the secure data to be entered has been determined, the secure processor 135 and the general processor 120 may perform the verification in a substantially similar manner as discussed above with reference to the first set of components of FIG. 2. Furthermore, upon completion of the verification, the disconnect from the secure processor 135 and the connect to the general processor 120 of the components may be automatic. The automatic connect/disconnect may also be substantially similar to the process discussed above with reference to the first set of components of FIG. 2.

It should be noted that the second set of components of FIG. 3 and the third set of components of FIG. 4 may also include an indicator that provides an indication to the user that secure data may be entered and will be securely forwarded for purposes of verification. The indication may provide the user with at least a sense of security that the secure data will not be intercepted by a rogue application.

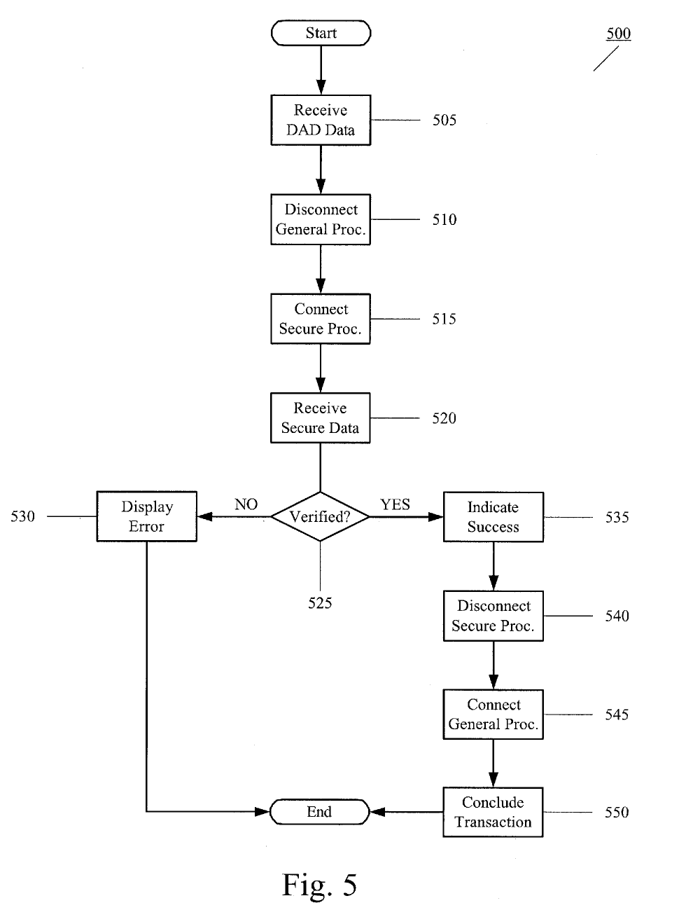

FIG. 5 shows a method 500 for performing a secure transaction according to an exemplary embodiment of the present invention. The method 500 will be described with reference to the MU 100 of FIG. 1 and the configuration of components of FIGS. 2-4. The method 500 may apply to any of the configurations described above with reference to FIGS. 2-4.

It should be noted that the method 500 may include a preliminary step with reference to the first set of components of FIG. 2. Specifically, the method 500 may include a step where the secure key 110a is activated. The secure key 110a may indicate to the general processor 120 that secure data is to be entered. The secure data may be, for example, raw data from a remote source such as a credit card or a PIN for a debit card.

In step 505, secure data is received in a form of raw data from the DAD 115. As discussed above, the DAD 115 may be or include a variety of different devices such as a magnetic strip reader, a RFID reader, a scanner, etc. Thus, if the remote source is a “smart card” that utilizes RFID technology, the DAD 115 may be a RFID reader that receives the RFID data from the “smart card.” With reference to the second and third set of components of FIGS. 3-4, respectively, the secure data being received may indicate to the general processor 120 that secure data is and may further be received (e.g., receiving CVN/PIN via the DIA 110).

In step 510, the general processor 120 may be disconnected from the components. With reference to the first and second set of components of FIGS. 2-3, respectively, the display 105 and the DIA 110 may be disconnected while, with reference to the third set of components of FIG. 4, the display 105 may be disconnected. In step 515, the secure processor 135 may be connected to the components. Thus, the secure data may be received by the secure processor 135 in step 520. That is, the raw data from the DAD 115 may be forwarded to the secure processor 135 for processing. When further secure data such as the CVN or the PIN is received via the DIA 110, the secure processor 135 may receive the further secure data as well.

In step 525, the secure processor 135 verifies the secure data. The verification performed by the secure processor 135 may be whether the raw data from the remote source is valid; whether the further secure data corresponds to the raw data; etc. If the secure processor 135 determines that the secure data is not valid, the method 500 continues to step 530 where an error message is shown on the display 105. Specifically, the error message may indicate that the transaction has failed.

If the secure processor 135 determines that the secure data is valid, the method 500 continues to step 535 where the secure processor 135 indicates to the general processor 120 that the transaction was successful. That is, the transaction may be allowed to be completed. The secure processor 135 may forward encoded data to the general processor 120 to be used for completing the transaction.

In step 540, the secure processor 135 disconnects from the components. With reference to the first and second set of components of FIGS. 2-3, respectively, the secure processor 135 may disconnect from the display 105 and the DIA 110. With reference to the third set of components of FIG. 4, the secure processor 135 may disconnect from the display 105. In step 545, the general processor 120 may re-connect to the components. In step 550, the general processor 120 may conclude the transaction.

It should be noted that the above exemplary embodiments may include alterations to provide a higher security. Thus, the configurations described above with reference to the first, second and third set of components of FIGS. 2-4, respectively, are only exemplary. In another exemplary embodiment, the DIA 110 may only be connected to the secure processor 135. Thus, the secure processor 135 may determine whether an input from the DIA 110 is to be encrypted. In such an exemplary embodiment, all sensitive data becomes encrypted so that even if a rogue application is capable of accessing the data, the encryption prevents the sensitive data to become available. In a further exemplary embodiment, the DAD 115 may only be connected to the secure processor 135. Thus, only the secure processor 135 has access to the raw data from the remote source.

It should also be noted that other security provisions may be placed onto the MU 100 to prevent a rogue application from having access to the MU 100. For example, the other security provisions may prevent an installation in which the rogue application may additionally be installed. The other security provisions may include a multi-part key that must be entered prior to the general processor 120 and/or the secure processor 135 allowing the installation. The multi-part key may be known to predetermined parties who do not share their respective part of the key. In another example, the MU 100 may simply prevent installation of executable programs. In particular, in a retail environment where the MU 100 is a cash register, the cash register may only include executable programs that are part of the sales transaction.

In a further example, the secure processor 135 may prevent data such as that received via the DAD 115 from being transmitted when the secure data such as a PIN is entered when the MU 100 is in a non-secure mode. That is, the data from the DAD 115 and the secure data may only be transmitted to the secure processor 135 when the MU 100 is in a secure mode. This may prevent a lockout feature of the MU 100 that effectively does not allow the user from entering the data via the DAD 115 and/or the DIA 110. In yet a further example, the secure processor 135 may not transmit data from the DIA 110 after a transaction when the secure data matches a recent transaction. The MU 100 may include a functionality incorporated in respective applications relating to a transaction to indicate a reason as to why the MU 100 has performed the lockout feature. For example, a reason may be that the secure data and other entered data matches.

The exemplary embodiments of the present invention enable a secure transaction to be performed without a need for a separate module. The secure transaction may prevent a rogue application from intercepting any secure data. The secure data may be forwarded from a DIA to a secure processor through a manual or automatic process. For example, if a secure key is activated, the secure processor and a general processor may manually be made aware that the secure data is to be entered. In another example, the secure processor and the general processor may automatically be made aware that the secure data is to be entered when activity is detected from a connection to a DAD. Because no separate module is required for the secure transaction, no redundant component such as another DIA and/or another display is required.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
a first processor being connected to a display, a data input arrangement, and a data acquisition device in a first mode of operation, the first mode of operation relating to performing non-secure operations;
a second processor being connected to the display, the data input arrangement, and the data acquisition device in a second mode of operation, the second mode of operation relating to performing a secure operation, the secure operation relating to a sales transaction,
wherein, when the device is in the second mode of operation, the data acquisition device receives secure data from a remote source, the secure data being forwarded to the second processor to determine a success of the sales transaction.

2. The device of claim 1, wherein the second processor is connected to the data acquisition device via the first processor.

3. The device of claim 1, wherein the data acquisition device is at least one of a magnetic strip reader, a radio frequency identification reader, and a scanner.

4. The device of claim 1, wherein the data input arrangement includes a secure key.

5. The device of claim 4, wherein the secure key indicates to the first processor to disconnect from the display and the data input arrangement.

6. The device of claim 5, wherein the first processor indicates to the second processor to connect to the display and the data input arrangement.

7. The device of claim 1, further comprising:
an indicator indicating that the second processor is connected to the display, the data input arrangement, and the data acquisition device.

8. The device of claim 1, wherein the first processor disconnects from the display, the data input arrangement, and the data acquisition device when an activity is detected from the data acquisition device.

9. The device of claim 1, wherein the device includes a security provision to prevent an installation of executable programs to the first and second processors.

10. The device of claim 9, wherein the security provision includes at least two keys, a providing of the at least two keys enabling an installation of executable programs to at least one of the first and second processors.

11. A method, comprising:
connecting a first processor to a display, a data input arrangement, and a data acquisition device when in a first mode of operation, the first mode of operation relating to performing non-secure operations;
connecting a second processor to the display, the data input arrangement, and the data acquisition device when in a second mode of operation, the second mode of operation relating to performing secure operations of the device, the secure operation relating to a sales transaction,
wherein, in the second mode of operation, the data acquisition device receives secure data from a remote source, the secure data being forwarded to the second processor to determine a success of the sales transaction.

12. The method of claim 11, wherein the connecting of the second processor to the data acquisition device is performed via the first processor.

13. The method of claim 11, wherein the data acquisition device is at least one of a magnetic strip reader, a radio frequency identification reader, and a scanner.

14. The method of claim 11, further comprising:
activating a secure key.

15. The method of claim 14, further comprising:
indicating to the first processor to disconnect from the display and the data input arrangement.

16. The method of claim 15, further comprising:
indicating to the second processor to connect to the display and the data input arrangement.

17. The method of claim 11, further comprising:
generating an indication indicating that the second processor is connected to the display, the data input arrangement, and the data acquisition device.

18. The method of claim 11, further comprising:
detecting an activity from the data acquisition device.

19. The method of claim 18, further comprising:
upon the detecting, disconnecting the first processor from the display, the data input arrangement, and the data acquisition device.

20. A device, comprising:
a first processing means for performing non-secure operations when in a first mode of operation, the first processing means being connected to a display, a data input arrangement, and a data acquisition device in the first mode of operation;
a second processing means for performing a secure operation when in a second mode of operation, the secure operation relating to a sales transaction, the second processing means being connected to the display, the data input arrangement, and the data acquisition device in the second mode of operation,
wherein, when the device is in the second mode of operation, the data acquisition device receives secure data from a remote source, the secure data being forwarded to the second processing means to determine a success of the sales transaction.
